(19) United States
(12) Patent Application Publication
(10) Pub. No.: US 2023/0080314 A1
(43) Pub. Date: Mar. 16, 2023

(54) DEACETYLATION AND CROSSLINKING OF CHITIN AND CHITOSAN IN FUNGAL MATERIALS AND THEIR COMPOSITES FOR TUNABLE PROPERTIES

(71) Applicant: MycoWorks, Inc., Emeryville, CA (US)

(72) Inventors: Jordan Chase, El Cerrito, CA (US); Nicholas Wenner, Sebastopol, CA (US); Philip Ross, San Francisco, CA (US); Mike Todd, Portsmouth, NH (US)

(21) Appl. No.: 17/989,935

(22) Filed: Nov. 18, 2022

Related U.S. Application Data
(63) Continuation of application No. 16/353,979, filed on Mar. 14, 2019.
(60) Provisional application No. 62/643,068, filed on Mar. 14, 2018.

(51) Int. Cl. C08B 37/08; C08L 5/08

(52) U.S. Cl. CPC C08B 37/003; C08L 5/08; C08L 2312/00

(57) ABSTRACT

Fungal crosslinked structures, fungal crosslinking systems, and methods for crosslinking a fungal material. The crosslinked fungal material described herein comprises a variety of crosslinkers, crosslinking sites, and various combinations of crosslinks, each forming unique structures. The crosslinked fungal material comprises at least one crosslinking compound attached to a bonding site. The fungal crosslinking system includes a preparation unit, an impregnating unit, a crosslinking unit and a rinsing unit. The preparation unit may partially deacetylate chitin within the fungal material and within chitin nanowhiskers. The impregnating unit impregnates the fungal material with chitin nanowhiskers. The crosslinking unit is configured to crosslink the fungal material and chitin nanowhiskers via genipin to create a composite material. The rinsing unit rinses and removes unreacted genipin material thereby rendering a crosslinked composite material. The resulting crosslinked composite material is stronger and more flexible than the original fungal material with improved chemical and mechanical properties.

This application is a continuation application based on U.S. patent application Ser. No. 16/353,979 filed Mar. 14, 2019, and which claims priority to: U.S. Provisional Patent Application No. 62/643,068, filed on Mar. 14, 2018. The disclosures of these applications are incorporated herein by reference as if set out in full.

### BACKGROUND OF THE DISCLOSURE

### Technical Field of the Disclosure

The present disclosure relates generally to chitin and chitosan compositions, especially to deacetylation and crosslinking of chitin and chitosan in fungal materials. The invention also relates to methods for making the compositions.

### Description of the Related Art

The properties and applications of fungal materials are strongly linked to their morphology, structure and size. Fungal materials generally comprise a network of interlocking branched hollow tubes called hyphae. Hyphae contain a unique molecular compound called chitin. Chitin is also the main constituent in the shells of crustaceans and is the most abundant naturally occurring biopolymer other than cellulose. Chitosan is derived from chitin and can be formed by deacetylation of chitin. Chitosan is commercially available in a wide variety of molecular weights (e.g., 10-1,000 kDa) and usually has a degree of deacetylation ranging between 70% and 90%. Chitosan is used for a wide variety of purposes including plant care, cosmetics additives, food and nutrition supplements and medical care.

Usually, fungal material grows to a specified thickness and shape as a singular, homogenous structure. Alternately, fungal materials may form a composite with other materials such as cotton textiles and/or chitin nanowhiskers. Such composites can be used for various applications and are widely utilized in textiles, packaging and building materials.

The properties of fungal materials may be controlled by various methods, including crosslinking. Crosslinking allows for control of several important parameters including tensile strength, tear strength, abrasion resistance, in addition to various chemical properties such as dye fixation. Crosslinking may also help to determine how putrescible or stabilized a given material may be.

At a molecular level, crosslinking involves the reaction of long-chain fibers with crosslinking molecules to form molecular bonds, such as amide bonds, between the fibers. Such amide bonds resist hydrolysis and confer structural rigidity, especially in resonance-stabilized structures. Numerous different crosslinked fungal composites have been achieved through various chemical reaction schemes.

Distinctly different chemical bonds are available for crosslinking chitin, when compared to collagen. Animal leathers are composed of collagen, which is an organic, fibrous material. Mycelium, on the other hand, is comprised of chitin. Chitin is a molecularly-distinct organic fiber material with a distinct make-up of hydroxyl versus amine groups available for chemical crosslinking. Further, whereas cellulosic materials have been shown to be physically altered through crosslinking, fungal materials comprised of chitin have not been successfully crosslinked. Fungal composites must be altered through crosslinking in order to exhibit equivalent properties and characteristics with animal skins.

Various processes exist for the treatment of chitinaceous materials to obtain chitin. One such process involves chemical deacetylation of chitin. While convenient, chemical deacetylation is relatively costly. This deacetylation method also results in the degradation (break-down) of pure chitin, and is not employed as a means of crosslinking chitin fibers with other chitin fibers, nor with other materials such as cellulosic textiles.

Yet another process involves crosslinking polymeric substances and a method for preparing the crosslinked polymeric substance. In general, the crosslinked polymeric substance has a measurable amphoteric capacity and is prepared from natural chitin or regenerated chitin. This method for preparing crosslinked fungal materials does not, however, control the chemical and mechanical properties of the fungal materials.

Therefore, there is a need for altering fungal materials and composites with crosslinking chemistries such that they are able to compete in consumer markets with animal leathers and the like. Such altered fungal material would also exhibit improved tensile strength, tear strength, abrasion resistance, dye fixation, and non-putrescible behaviors. The present embodiments accomplish these objectives.

### SUMMARY OF THE INVENTION

To minimize the limitations found in the existing systems and methods, and to minimize other limitations that will be apparent upon the reading of this specification, the present invention includes a crosslinked, fungal composite with several unique crosslinking features. Methods for crosslinking fungal materials are also disclosed.

One embodiment of the present invention involves a preparation unit, herein also referred to as a deacetylating unit, that partially deacetylates chitin within the fungal material and within chitin nanowhiskers. Deacetylation is achieved by submersion of chitin nanowhiskers or other fungal material in an aqueous solution of 40% by weight of sodium hydroxide at an optimal temperature for a deacetylating time period. An impregnating unit is configured to impregnate the fungal material with chitin nanowhiskers through soaking and agitation. In addition, a crosslinking unit is designed to crosslink the fungal material and chitin nanowhiskers with themselves and each other using genipin material. In the preferred embodiment, commercially available genipin powder is dissolved in acetic acid to create a genipin first mixture. The genipin first mixture is then mixed with a crosslinking solution to generate a genipin second mixture. Preferably, the crosslinking solution has a pH rate ranging from 2 to 3. The genipin second mixture is applied to the fungal material at a genipin utilization rate to create a genipin fungal mixture which is incubated at an incubation condition with agitation to create a composite material. The genipin utilization rate ranges from 0.05%-4% w/w to the weight of the genipin polymer. In the present embodiment, the incubation condition for incubating the genipin fungal mixture includes an incubation time ranging from 40 minutes to several hours and an incubation temperature of 25 degree Celsius with agitation.

A rinsing unit is configured to rinse the composite material with water thereby neutralizing the composite material to an optimum pH value of 7. Upon neutralization, unreacted genipin material is removed from the composite material to generate a crosslinked composite material. The resulting crosslinked composite material is stronger and more flexible than the original fungal material with improved chemical and mechanical properties.

Another embodiment of the present invention includes a crosslinked material that is a composite of a fungal material and a secondary constituent, wherein the two materials are chemically and/or molecularly crosslinked. The implementation of crosslinking may utilize bonding at hydroxyl group sites, amine group sites, carbon-carbon bond sites, and the like. In addition, said composite structures may include material wherein a fungal material is physically integrated with a second material, wherein the composite is physically strengthened and/or altered and/or improved through crosslinking, such that the final, crosslinked material exhibits properties that are greater than the sum of the constituents alone. For example, a crosslinked material may exhibit an increase in tensile strength that is greater than the sum of each individual constituent. Furthermore, a tertiary material or molecule may serve as a crosslink between a fungal material and a secondary constituent such that the complex of crosslinked materials exhibits beneficial properties that are greater than the sum of the constituents alone.

The nature of crosslinking in such composite material is such that a third compound or molecule may also serve as a crosslink between the initial two materials. For example, a fungal material may crosslink to itself, or a fungal material may be crosslinked to a secondary constituent (i.e.; nanowhiskers). In another example, said secondary constituent may crosslink to itself. In yet another example, the crosslinking compound or molecule may agglomerate into larger, polymeric chains that are then bonded to the fungal material or the secondary constituent.

A first objective of the present invention is to provide a structure comprised of fungal materials and their composites that is chemically crosslinked in order to control the mechanical and chemical properties of the fungal materials and their composites.

A second objective of the present invention is to successfully alter, preserve, and strengthen a fungal material composite such that it can behave and perform akin to an animal leather. This may be achieved based on the unique molecular structure of chitin-based fungal materials and their composites.

These and other advantages and features of the present invention are described with specificity so as to make the present invention understandable to one of ordinary skill in the art.

### BRIEF DESCRIPTION OF THE DRAWINGS

Elements in the figures have not necessarily been drawn to scale in order to enhance their clarity and improve understanding of these various elements and embodiments of the invention. Furthermore, elements that are known to be common and well understood to those in the industry are not depicted in order to provide a clear view of the various embodiments of the invention. Thus, the drawings are generalized in form in the interest of clarity and conciseness.

FIG. 1 illustrates a block diagram of a fungal crosslinking system in accordance with one embodiment of the present invention;

FIG. 2 illustrates a high-level flowchart of a method for crosslinking a fungal material utilizing the fungal crosslinking system in accordance with the preferred embodiment of the present invention;

FIG. 3 illustrates a flowchart of the method for crosslinking the fungal material in accordance with the preferred embodiment of the present invention;

FIG. 4 is an SEM image illustrating the chainlike filamentous fiber structure of the hyphae that are comprised of chitin;

FIG. 5 illustrates a simple crosslinking system between a pair of chitin fibers such as would be present in fungal materials and their composites;

FIG. 6 illustrates the acetamide group, or amine group, bonding site for the various crosslinking molecules in accordance with several embodiments of the present invention;

FIG. 7 illustrates the hydroxyl bonding sites for the different crosslinking molecules in accordance with several embodiments of the present invention;

FIG. 8 illustrates the process of deacetylation of chitin into chitosan in accordance with one embodiment of the present invention; and

FIG. 9 illustrates the enhanced tensile strength of polysaccharide material crosslinked with vegetable tannin versus natural polysaccharide material.

### DETAILED DESCRIPTION OF THE DRAWINGS

In the following discussion that addresses a number of embodiments and applications of the present invention, reference is made to the accompanying drawings that form a part hereof, and in which is shown by way of illustration specific embodiments in which the invention may be practiced. It is to be understood that other embodiments may be utilized and changes may be made without departing from the scope of the present invention.

Various inventive features are described below that can each be used independently of one another or in combination with other features. However, any single inventive feature may not address any of the problems discussed above or only address one of the problems discussed above. Further, one or more of the problems discussed above may not be fully addressed by any of the features described below.

As used herein, the singular forms “a”, “an” and “the” include plural referents unless the context clearly dictates otherwise. “And” as used herein is interchangeably used with “or” unless expressly stated otherwise. As used herein, the term “about” means +/−5% of the recited parameter. All embodiments of any aspect of the invention can be used in combination, unless the context clearly dictates otherwise.

Unless the context clearly requires otherwise, throughout the description and the claims, the words “comprise”, “comprising”, and the like are to be construed in an inclusive sense as opposed to an exclusive or exhaustive sense; that is to say, in the sense of “including, but not limited to”. Words using the singular or plural number also include the plural and singular number, respectively. Additionally, the words “herein,” “wherein”, “whereas”, “above,” and “below” and words of similar import, when used in this application, shall refer to this application as a whole and not to any particular portions of the application.

The description of embodiments of the disclosure is not intended to be exhaustive or to limit the disclosure to the precise form disclosed. While the specific embodiments of, and examples for, the disclosure are described herein for illustrative purposes, various equivalent modifications are possible within the scope of the disclosure, as those skilled in the relevant art will recognize.

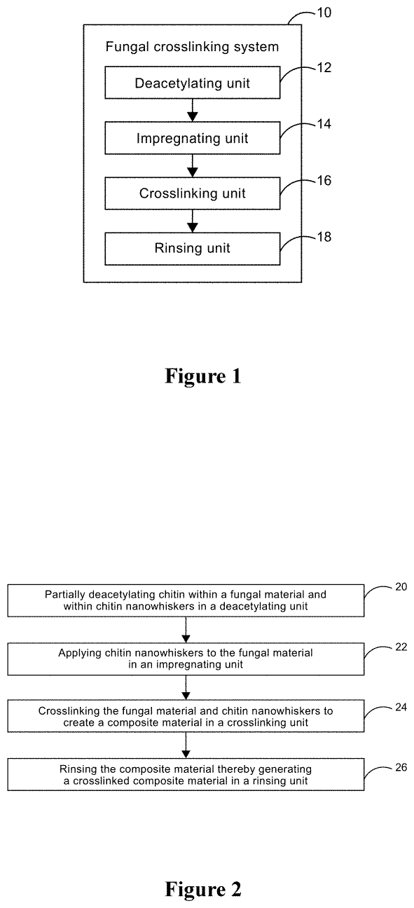

Referring to FIG. 1, a method for crosslinking a fungal material utilizing a fungal crosslinking system 10 for crosslinking a fungal material and/or fungal composite material with itself and/or each other is illustrated. Crosslinking allows for control of many useful fungal properties, including mechanical properties such as tensile strength, tear strength, abrasion resistance and other chemical properties such as dye fixation. FIG. 9 exemplifies this increase in strength, showing the strength increase of a cellulosic, polysaccharide material that was crosslinked with vegetable tannin versus a natural polysaccharide material.

The fungal crosslinking system 10 comprises a preparation unit 12, which in the preferred embodiment is a deacetylation preparation unit, an impregnating unit 14, a crosslinking unit 16 and a rinsing unit 18. In one embodiment, the preparation unit 12 partially deacetylates chitin within the fungal material. If the impregnating unit calls for the addition of the composite material, chitin nanowhiskers and the fungal material are submerged in an aqueous solution of 40% by weight of sodium hydroxide at an optimal temperature for a deacetylating time period. In the preferred embodiment, the optimal temperature is 80 degrees Celsius and the deacetylating time period ranges from one minute to ten hours to achieve degrees of acetylation from 1% to 50% as desired.

The impregnating unit 14 is configured to impregnate the fungal material with chitin nanowhiskers and the crosslinking unit 16 through soaking and agitation. In a first embodiment, the crosslinking unit 16 is designed to crosslink the fungal material and composite material (such as cellulosic textiles) with themselves and each other. In said first embodiment, crosslinking is also achieved without the addition of a deacetylating agent such as genipin.

In a second embodiment, the crosslinking unit 16 is designed to crosslink the fungal material and composite (such as cellulosic textiles) with themselves and each other using genipin material. In order to create a genipin first mixture, commercially available genipin powder is dissolved in acetic acid. The genipin first mixture is then mixed with a mixing solution to generate a genipin second mixture. The mixing solution has a pH rate ranging from 2 to 3. In said second embodiment of the invention, the genipin second mixture is applied to the fungal material at a genipin utilization rate to create a genipin fungal mixture which is incubated at an incubation condition with agitation to create a composite material. The genipin utilization rate ranges from 0.05%-4% w/w to the weight of the genipin polymer. Preferably, the incubation condition for incubating the genipin fungal mixture includes an incubation time of 40 minutes to several hours and an incubation temperature of 25 degrees Celsius with agitation.

The rinsing unit 18 rinses the composite material with water thereby neutralizing the composite material to an optimum pH value of 7 and removes unreacted genipin material to generate a crosslinked composite material. The resulting crosslinked composite material is stronger and more flexible than the original fungal material and comprises improved chemical and mechanical properties.

FIG. 2 illustrates a high-level flowchart of a chemical method for crosslinking the fungal material utilizing genipin material. As illustrated in FIG. 2, the method of the second embodiment of the present invention commences by partially deacetylating chitin within the fungal material and within chitin nanowhiskers in the deacetylating unit as shown in block 20. Next, the fungal material is applied with chitin nanowhiskers in the impregnating unit as shown in block 22. Thereafter, the fungal material and chitin nanowhiskers are crosslinked to create the composite material in the crosslinking unit as shown in block 24. Finally, the rinsing unit rinses the composite material thereby generating the crosslinked composite material as shown in block 26.

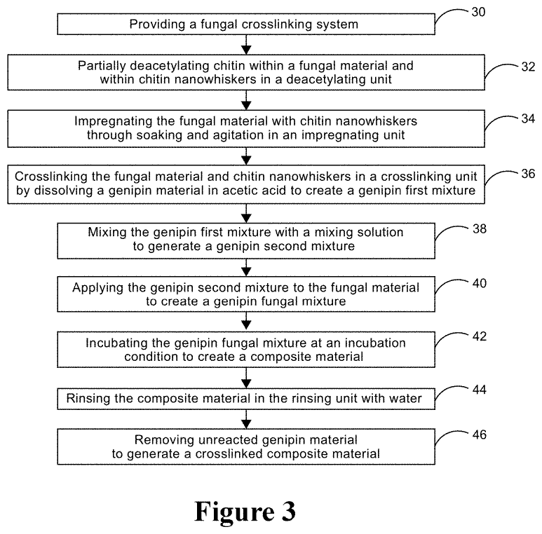

FIG. 3 illustrates a flowchart that describes the method for crosslinking the fungal material in detail. The crosslinking method starts by providing the fungal crosslinking system as shown in block 30. Next, chitin within the fungal material and within chitin nanowhiskers is partially deacetylated in the deacetylating unit as indicated at block 32. In this step of partial deacetylation, chitin nanowhiskers and the fungal material are submerged in the aqueous solution of sodium hydroxide at the optimal temperature for the deacetylating time period.

Thereafter, the fungal material is impregnated with chitin nanowhiskers through soaking and agitation in the impregnating unit as shown in block 34. Next, the fungal material and chitin nanowhiskers are crosslinked in the crosslinking unit by dissolving the genipin material in acetic acid to create a genipin first mixture as shown in block 36. Then, the genipin first mixture is mixed with the mixing solution to generate the genipin second mixture as shown in block 38. Upon generating the genipin second mixture, the genipin second mixture is applied to the fungal material at the genipin utilization rate to create the genipin fungal mixture as indicated at block 40. Next, the genipin fungal mixture is incubated at the incubation condition with agitation to create the composite material as shown in block 42. Thereafter, the composite material is rinsed in the rinsing unit with water thereby neutralizing the composite material to the optimum pH value as shown in block 44. Finally, the unreacted genipin material is removed to generate the crosslinked composite material as indicated at block 46.

In some embodiments, the above-described crosslinking methods are applied to leather-like fungus-based materials or composites with the aim of increasing tensile strength, tear strength, flexibility and other desirable qualities within that material. Notably, the present structures and methods control the chemical and mechanical properties of fungal materials and their composites for applications in textiles, packaging, building materials, and other industries where such materials are utilized.

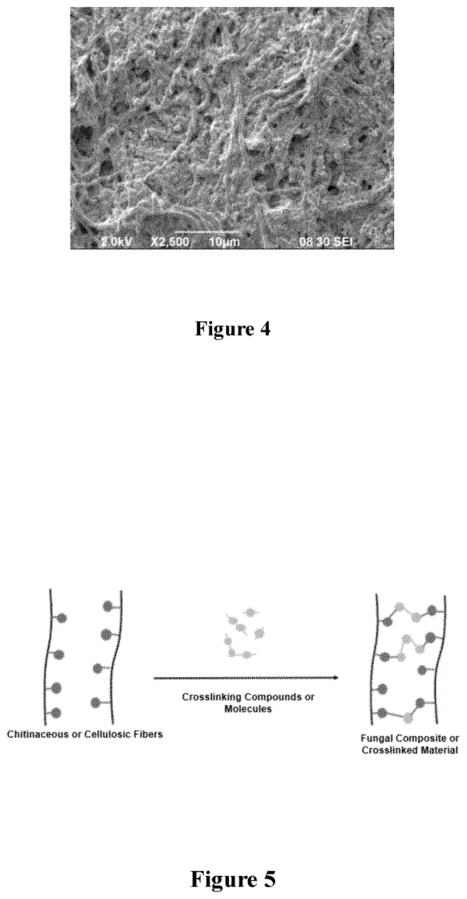

The physical crosslinking of fungal material is achieved by chemically linking the branched, filamentous fibers contained in fungal material. As shown in the SEM image of FIG. 4, the strands of mycelium, also called Hyphae, comprise spaghetti-like strands made of chitin. A simple diagrammatic representation of the crosslinking of chitin is shown in FIG. 5.

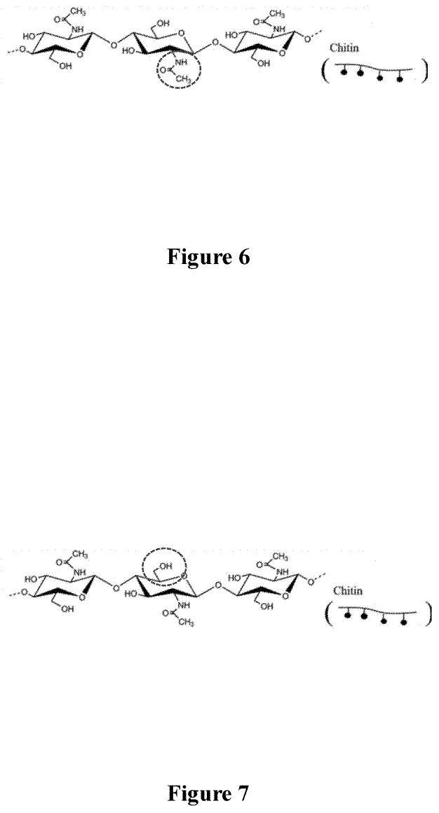

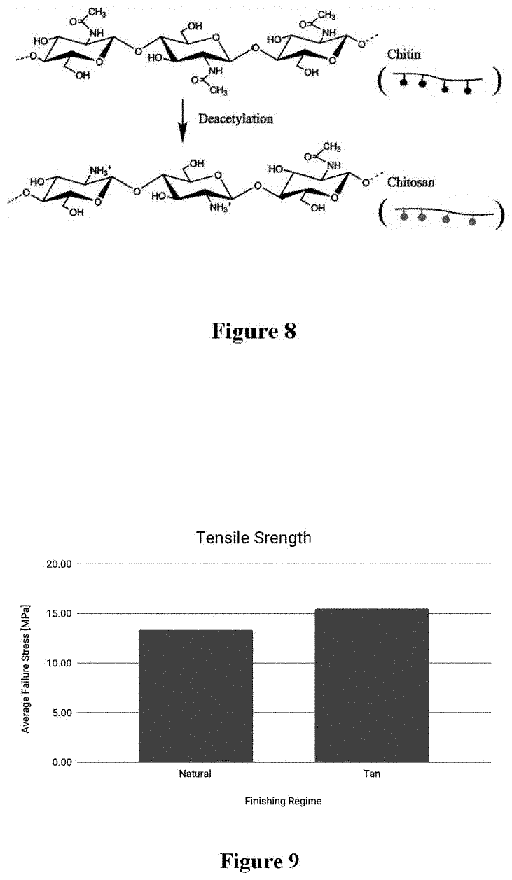

A third embodiment of the present invention comprises a crosslinked fungal composite material wherein the acetamide groups on the chitin chain are targeted for modification, as shown in FIG. 6. The acetamide groups on the chitin are utilized to create a bonding site for compounds that attach through an amide bond. Compounds that attached through an amide bond include glutaraldehyde, metal-complex tannins, and synthetic tannins (“syntans” or “syntan compounds”). In some embodiments, the acetamide groups are deacetylated into amine groups. Notably, deacetylated chitin is also referred to as chitosan.

A fourth embodiment of the present invention comprises a crosslinked fungal composite wherein the links are created by phenolic compounds such as vegetable tannins, among polysaccharides (sugar molecules) which exist on the hyphal cells. Such a crosslinked fungal material would exhibit links between bonding sites on the hydroxyl groups of the polysaccharides. Such hydroxyl groups of the polysaccharides are highlighted by a dashed circle in FIG. 7. These polysaccharide bonding sites may also be on the cellulosic material that is used as the composite along with the fungal material, such as a cotton textile layer. As described above, links may also be created by the partial degradation of chitin molecules into chitosan followed by a reaction with genipin.

Another embodiment of the present invention utilizes bonding sites on the carbonaceous backbone of the chitin molecule itself. Binding to the carbonaceous backbone may be achieved by various methods known to persons skilled in the art and as described herein.

Further embodiments of the present invention comprise combinations of the above bonding mechanisms, wherein a crosslinking compound or molecule acts as a bridge between dissimilar bonding sites, resulting in crosslinked chitin or chitosan fibers. Bonding between dissimilar bonding sites may include: hydroxyl to carbon bonding, hydroxyl to amine bonding, carbon to carbon bonding, carbon to amine bonding, and the like.

A summary of distinct embodiments of crosslinked fungal composites is provided in Table 1 below:

TABLE 1

| Crosslinking | | | |
|---|---|---|---|
| Compound or | | | |
| Molecule | Link A | Link B | Bonding-site |
| Glutaraldehyde | Chitinand/or | Chitinand/or | Hydroxyl and/or |
| (condensation) | Polysaccharide | Polysaccharide | Amine Groups |
| Vegetable Extract | Polysaccharide | Polysaccharide | Hydroxyl Groups |
| (phenolic or | and/or Chitin | and/or Chitin | |
| polyphenolic | | | |
| compounds) | | | |
| Syntans (synthetic | Chitinand/or | Chitinand/or | Amine Groups |
| tannins) | Polysaccharide | Polysaccharide | |
| Metal Complex | Deacetylated | Deacetylated | Carboxyl Groups |
| (Mineral) | Chitin | Chitin | |
| Genipin | Deacetylated | Deacetylated | Amine Group on |
| | Chitin | Chitin | Chitosan |
| Carbon-Carbon | Carbon | Carbon | Covalent |
| Bonding | | | |

Combinations of the above

Table 1 shows that chitin-containing and/or polysaccharide-containing compositions may include crosslinking compounds attached to bonding sites. If a bonding site comprises, for example, a hydroxyl group and/or an amine group, then a glutaraldehyde crosslinking compound may serve as a suitable crosslinking molecule. Also, if a hydroxyl group bonding site is present, then phenolic compounds such as those found in vegetable extracts may serve as a suitable crosslinking molecule. Another embodiment illustrated in Table 1 involves an amine group bonding site. If an amine group bonding site is present, then a syntan compound (synthetic tannins) may serve as a suitable crosslinking molecule.

Yet another embodiment illustrated in Table 1 comprises a carboxyl group bonding site. If a carboxyl group bonding site is present, then a metal complex may serve as a suitable crosslinking molecule. In addition, covalent carbon-carbon bonds may be formed using carbonaceous linker segments. As described in Table 1, various combinations of the above-described crosslinking compounds and bonding sites are contemplated in the present invention.

Further to the above, crosslinking may be facilitated by a secondary constituent and a tertiary crosslinking compound. Said tertiary compound may form a crosslink between the fungal material and the secondary constituent. While said fungal material crosslinks to the secondary constituent, it may also crosslink to itself. Similarly, the secondary material may crosslink to itself. Finally, the tertiary compound may agglomerate into larger, polymeric chains that are then bonded to the fungal material and/or the secondary constituent. As a direct result of these heterogeneous conformational and chemical arrangements, the resulting crosslinked materials often exhibit tensile strength that is greater than the sum of the fungal material and secondary constituent alone, as exemplified in FIG. 9.

The foregoing description of the preferred embodiment of the present invention has been presented for the purpose of illustration and description. It is not intended to be exhaustive or to limit the invention to the precise form disclosed. Many modifications and variations are possible in light of the above teachings. It is intended that the scope of the present invention not be limited by this detailed description, but by the claims and the equivalents to the claims appended hereto.

We claim:

1. A method for crosslinking a fungal material utilizing a fungal crosslinking system to create a crosslinked composite material stronger and more flexible than the original fungal material, the method comprising the steps of:
a) providing the fungal crosslinking system having a preparation unit, an impregnating unit, a crosslinking unit and a rinsing unit;
b) partially deacetylating chitin within the fungal material and within chitin nanowhiskers in the deacetylating unit by submerging chitin nanowhiskers and the fungal material in an aqueous solution of sodium hydroxide at an optimal temperature for a deacetylating time period;
c) impregnating the fungal material with chitin nanowhiskers through soaking and agitation in the impregnating unit;
d) crosslinking the fungal material and chitin nanowhiskers in the crosslinking unit by (i) dissolving a genipin material in acetic acid to create a genipin first mixture, (ii) mixing the genipin first mixture with a mixing solution to generate a genipin second mixture and (iii) applying the genipin second mixture to the fungal material at a genipin utilization rate at an incubation condition with agitation to create a composite material;
e) rinsing the composite material in the rinsing unit with water thereby neutralizing the composite material to an optimum pH value; and
f) removing unreacted genipin material to generate a crosslinked composite material.

2. The method of claim 1 wherein the optimal temperature for partial deacetylation of chitin is around 80 degrees and the deacetylating time period ranges from one minute to ten hours.

3. The method of claim 1 wherein the mixing solution has a pH rate ranging from 2 to 3.

4. The method of claim 1 wherein the genipin utilization rate ranges from 0.05%-4% w/w to the weight of the genipin polymer.

5. The method of claim 1 wherein the incubation condition for incubating the genipin fungal mixture includes an incubation time ranging from 40 minutes to several hours and an incubation temperature of 25 degree Celsius.

6. The method of claim 1 wherein the composite material is neutralized at the optimum pH value of 7.

7. A method for crosslinking a fungal material utilizing a fungal crosslinking system, the method comprising the steps of:
a) providing the fungal crosslinking system having a deacetylating unit, an impregnating unit, a crosslinking unit and a rinsing unit;
b) partially deacetylating chitin within the fungal material and within chitin nanowhiskers in the deacetylating unit by submerging chitin nanowhiskers and the fungal material in an aqueous solution of sodium hydroxide at an optimal temperature for a deacetylating time period;
c) impregnating the fungal material with chitin nanowhiskers through soaking and agitation in the impregnating unit;
d) crosslinking the fungal material and chitin nanowhiskers in the crosslinking unit by (i) dissolving a genipin material in acetic acid to create a genipin first mixture, (ii) mixing the genipin first mixture with a mixing solution to generate a genipin second mixture and (iii) applying the genipin second mixture to the fungal material at a genipin utilization rate to create a genipin fungal mixture that being incubated at an incubation condition with agitation to create a composite material;
e) rinsing the composite material in the rinsing unit with water thereby neutralizing the composite material to an optimum pH value; and
f) removing unreacted genipin material to generate a crosslinked composite material with improved strength and flexibility.

8. A fungal crosslinking system comprising:
a deacetylating unit for partially deacetylating chitin within a fungal material and within chitin nanowhiskers;
an impregnating unit for impregnating the fungal material with chitin nanowhiskers;
a crosslinking unit for crosslinking the fungal material and chitin nanowhiskers, the crosslinking unit being configured to dissolve a genipin material in acetic acid to create a genipin first mixture, to mix the genipin first mixture with a mixing solution thereby generating a genipin second mixture and to apply the genipin second mixture to the fungal material at a genipin utilization rate to create a genipin fungal mixture that being incubated at an incubation condition with agitation to create a composite material; and
a rinsing unit for rinsing the composite material with water thereby generating a crosslinked composite material with increased strength and flexibility.

9. The fungal crosslinking system of claim 8, wherein the deacetylating unit partially deacetylates chitin within the fungal material and within chitin nanowhiskers by submerging chitin nanowhiskers and the fungal material in an aqueous solution of 40% by weight of sodium hydroxide at an optimal temperature for a deacetylating time period.

10. The fungal crosslinking system of claim 8 wherein the crosslinking unit utilize bonding at hydroxyl group sites, amine group sites including syntan tannins, carbon-carbon bond sites, aldehyde group sites including formaldehyde and glutaraldehyde, phenolic group sites including vegetable tannins and polysaccharides and metal complex sites.
